(19) United States
(12) Patent Application Publication
(10) Pub. No.: US 2003/0041906 A1
(43) Pub. Date: Mar. 6, 2003

(54) Cock

(75) Inventor: Satoru Setoguchi, Tokyo (JP)

Correspondence Address: LORUSSO a LOUD, 3137 Mt. Vernon Avenue, Alexandria, VA, 22305, US

(73) Assignee: FUJIYAMA REFINE CO., LTD.

(21) Appl. No.: 10/229,163

(22) Filed: Aug. 28, 2002

(30) Foreign Application Priority Data
Aug. 29, 2001 (JP) 2001-259728

(51) Int. Cl. F16K 11/06

(52) U.S. Cl. 137/625.12

(57) ABSTRACT

A cock according to the present invention comprises a cylindrical main body, a plug inserted into the main body liquid-tightly so as to be turned normally and reversely, a mounting flange mounted to the main body, a first cock part permitting a first inflow port and a first outflow port on the main body side to be opened and closed through a first connection port on the plug side, and a second cock part permitting a second inflow port and a final outflow port on the main body side to be opened and closed through a second connection port on the plug side, wherein the final outflow port is formed in the main body along a perpendicular direction, and the first cock part is controlled to start opening slightly later than the second cock part and also to start closing slightly earlier than the second cock part. The cock of the present invention is suitable for operation on a sink cabinet in a case of installing a water purifier and the like in a storage part under the sink cabinet, and also may control inflow and outflow of water to the water purifier and the like by somewhat staggering the time.

### BACKGROUND OF THE INVENTION

1. Field of the Invention

This invention relates to a cock useful for simultaneously controlling inflow and outflow of liquid to a liquid treating container such as a water purifier installed at a faucet portion of a water pipe, for instance, in a case of installing the container in a liquid pipe, through which the liquid is flowed under a predetermined pressure.

2. Description of the Prior Art

Inflow and outflow of water to a water purifier connected to a faucet portion of a water pipe are controlled simultaneously by a cock set up at an inlet side (an upstream side) of the water purifier, for instance.

The reason why the above structure is required is as follows. That is, if a cock is set up at a feed water part connected to an outlet side of the water purifier, control of the inflow and outflow of water to the water purifier with the cock brings about application of excessive pressure to the water purifier whose cross-sectional capacity is larger than that of the water pipe, so that the water purifier is damaged or deteriorated, unless a solidly structured water purifier is used.

Incidentally, in a case of installing a container such as the water purifier in the water pipe to concurrently control the inflow and outflow of water to the container with the cock that is set up at the inlet side of the container, a loss of hydraulic pressure in a pipe on a downstream side of the container as a result of stop of a liquid flow causes migration of miscellaneous germs from the downstream pipe into the container, so that the propagation of miscellaneous germs easily occurs.

In order to solve the above problem, and besides, to prevent the excessive pressure from being applied to the container when the liquid flow is stopped, it may be supposed that cocks are respectively set up in the pipe on the upstream side and the downstream side of the container. In this case, operation of closing the downstream side cock after closing the upstream side cock will do in a case of stopping the liquid flow, while operation of opening the upstream side cock after opening the downstream side cock will do in a case of starting the liquid flow.

However, it is complicated to operate separately the cocks that are set up in the pipe on the downstream side and the upstream side of the container, so that there is a danger of making a mistake in order of cock operations.

To solve the above problem, a present inventor has already proposed a cock as disclosed in U.S. Pat. No. 3,033,944.

The cock as disclosed in U.S. Pat. No. 3,033,944 will now be described with reference to FIGS. 23 and 24.

FIG. 23 is a cross-sectional view showing a cock mounted to the water purifier, and FIG. 24 is a schematic cross-sectional view showing a relation between a first cock part and a second cock part of the cock in FIG. 23.

Reference numeral 7 denotes a main body having an insertion port 70, and a plug 8 having a handle 80 at one end is inserted into the insertion port 70 liquid-tightly so as to be turned within a predetermined angle.

The plug 8 is restrained from its free turning by means of tightening a male screw part 83, which is at an end of the plug projecting from the main body 7, with a nut 84 through a spring washer (not shown) to the desired degree.

In the main body 7 and the plug 8, there are provided a first cock part 7a that controls the inflow of water to a treating container (the water purifier) 6 connected to the vicinity of a faucet of a water pipe (not shown) and a second cock part 7b that controls the outflow of water from the treating container 6.

The first cock part 7a has a first inflow port 71 and a first outflow port 72, which are formed in a portion of the main body 7 so as to extend from the insertion port 70 to the outer circumference respectively, and a first connection port 81, which is formed in the plug 8. The first inflow port 71 and the first outflow port 72 are structured to be opened through the first connection port 81 when the plug 8 is turned counterclockwise by 90 degrees from a closed position of the first cock part 7a, while being closed when the plug 8 is turned clockwise by 90 degrees.

The second cock part 7b has a second inflow port 73 and a second outflow port 74, which are formed in another portion of the main body 7, and a second connection port 82, which is formed in the plug 8. The second inflow port 73 and the second outflow port 74 are structured to be opened through the second connection port 82 almost concurrently with opening of the first inflow port 71 and the first outflow port 72 when performed through the first connection port 81, while being closed almost concurrently with closing of the first inflow port 71 and the outflow port 72 when performed.

In order to seal water running portions of the first cock part 7a and the second cock part 7b, O-rings 85, 86 and 87 are installed in required portions of a contact part of the main body 7 with the plug 8.

The first inflow port 71 is arranged to communicate with a water pipe (not shown), while the first outflow port 72 is arranged to communicate with an inlet 60 of the treating container 6 through a packing 75.

The second inflow port 73 is arranged to communicate with an outlet 61 of the treating container 6 through a packing 76, while the second outflow port 74 is arranged to communicate with a feed water pipe (not shown).

FIG. 23 shows a state that the first inflow port 71 and the first outflow port 72, as well as the second inflow port 73 and the second outflow port 74, are respectively opened so that tap water is flowing to the feed water pipe through the second cock part 7b after being flowed into the container 6 through the first cock part 7a for purification.

In this state, as shown in FIG. 24, the first inflow port 71, the first outflow port 72, the first connection port 81, the second inflow port 73 and the second outflow port 74 are aligned in a vertical direction in the drawing, whereas the connection port 82 of the second cock part 7b is formed one-sidedly so as to be inclined by a slight angle θ along a turning direction of the plug 8 on the occasion to open the cock.

As a result, the second inflow port 73 and the second outflow port 74 are closed slightly later than the first inflow port 71 and the first outflow port 72 when the plug 8 is turned in a direction to close the cock parts 7a, 7b, while being opened slightly earlier than the inflow port 71 and the outflow port 72 when the plug 8 is turned in a direction to open the cock parts 7a, 7b.

According to the cock, the outlet side of the treating container 6 is opened somewhat earlier than the inlet side thereof when the plug 8 is operated in a cock opening direction, while the outlet side of the treating container 6 is closed somewhat later than the inlet side thereof when the plug 8 is operated in the opposite direction, so that no excessive hydraulic pressure is applied to the treating container 6. For this reason, it is possible to manufacture the treating container 6 at lower cost, because of no need for manufacture of a solidly structured treating container.

In addition, a single cock is enough to perform the above operations, so that there is no danger of making a mistake in order of operations for inflow to and outflow from the treating container 6.

The cock as disclosed in U.S. Pat. No. 3,033,944 has the above availability, and is extremely convenient when used for the water purifier and the like installed on a wall and the like near a sink cabinet of a kitchen, for instance.

However, the water purifier and the like are often installed in a storage part under the sink cabinet of the kitchen to feed water, which is already treated with the water purifier and the like, to a sink through the feed water pipe and the like. In this case, since inflow/outflow operations of the water purifier and the like need to be performed on the sink cabinet, use of the cock as disclosed in U.S. Pat. No. 3,033,944 makes pipe arrangement complicated.

This is because in a case of installing the water purifier and the like under the sink cabinet, while setting up the cock on the sink cabinet for the inflow/outflow operations of the water purifier and the like, there is a need for pipe arrangement to connect an end part of the water pipe projecting from the sink cabinet upward to the side of the sink to the first inflow port of the cock, to communicate the first outflow port with the inlet of the water purifier and the like through the feed water pipe that is arranged in the manner of penetrating the top plate of the sink cabinet, and further to communicate the outlet of the water purifier and the like to a faucet-loaded pipe close to the sink through the similarly arranged feed water pipe.

### SUMMARY OF THE INVENTION

It is an object of the present invention to provide a cock suitable to perform inflow/outflow operations of a water purifier and the like on a sink cabinet in a case of installing the water purifier and the like in a storage part under the sink cabinet.

In order to achieve the above object, a cock according to the present invention comprises a main body having an insertion port formed in a perpendicular direction, a plug inserted into the main body liquid-tightly so as to be turned normally and reversely within a predetermined angle and having a handle at a head projecting from the main body, a mounting flange mounted to the main body, a first cock part that permits a first inflow port and a first outflow port respectively formed in the main body to be opened and closed through a first connection port formed in the plug, and a second cock part that permits a second inflow port and a final outflow port respectively formed in the main body to be opened and closed through a second connection port formed in the plug, wherein a portion of the final outflow port excluding an inlet thereof is formed in the main body to reach a head along a perpendicular direction, the first cock part and the second cock part are opened and closed concurrently through an operation of the plug, and the first cock part is controlled to start opening slightly later than a point of time when the second cock part starts opening, and also to start closing slightly earlier than a point of time when the second cock part starts closing.

### BRIEF DESCRIPTION OF THE DRAWINGS

The foregoing and other objects and features of the invention will become apparent from the following description of preferred embodiments of the invention with reference to the accompanying drawings, in which:

FIG. 1 is a schematic front view showing a state that a cock in a first embodiment is mounted to a top plate of a sink cabinet;

FIG. 2 is an enlarged longitudinal cross-sectional view, partly omitted, showing the cock in FIG. 1:

FIG. 3 is a cross-sectional view taken along arrow A-A in FIG. 2:

FIG. 4 is a bottom view of the cock in FIG. 2:

FIG. 5 is a cross-sectional view taken along arrow B-B in FIG. 2:

FIG. 6 is a cross-sectional view taken along arrow C-C in FIG. 2;

FIG. 7 is a cross-sectional view taken along arrow D-D in FIG. 2;

FIG. 8 is a cross-sectional view taken along arrow E-E in FIG. 2;

FIG. 9 is an enlarged cross-sectional view taken along arrow G-G in FIG. 6;

FIG. 10 is an enlarged cross-sectional view taken along arrow H-H in FIG. 7;

FIG. 11 is a cross-sectional view taken along arrow F-F in FIG. 2;

FIG. 12 is a schematic cross-sectional view showing an opened state of the cock in the first embodiment in a simplified form;

FIG. 13 is a schematic cross-sectional view showing a closed state of the cock in the first embodiment in a simplified form;

FIG. 14 is a partial longitudinal cross-sectional view showing a cock in a second embodiment according to the present invention;

FIG. 15 is a cross-sectional view taken along arrow I-I in FIG. 14;

FIG. 16 is a cross-sectional view taken along arrow J-J in FIG. 14;

FIG. 17 is a cross-sectional view taken along arrow K-K in FIG. 14;

FIG. 18 is a cross-sectional view taken along arrow L-L in FIG. 14;

FIG. 19 is a partial cross-sectional view taken along arrow M-M in FIG. 17;

FIG. 20 is a partial cross-sectional view taken along arrow N-N in FIG. 18;

FIG. 21 is a partial longitudinal cross-sectional view showing a state that a third cock part of the cock in the second embodiment is opened;

FIG. 22 is a partial longitudinal cross-sectional view showing a cock in a third embodiment according to the present invention;

FIG. 23 is a cross-sectional view showing a conventional cock mounted to a water purifier; and

FIG. 24 is a schematic cross-sectional view showing a relation between a first cock part and a second cock part of the cock in FIG. 23.

### DETAILED DESCRIPTION OF PREFERRED EMBODIMENTS

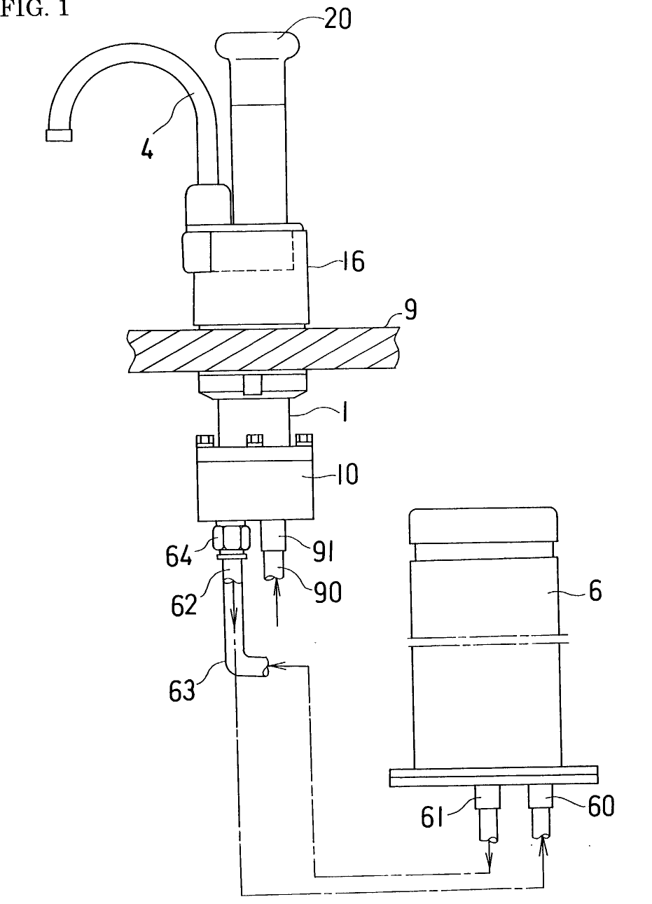

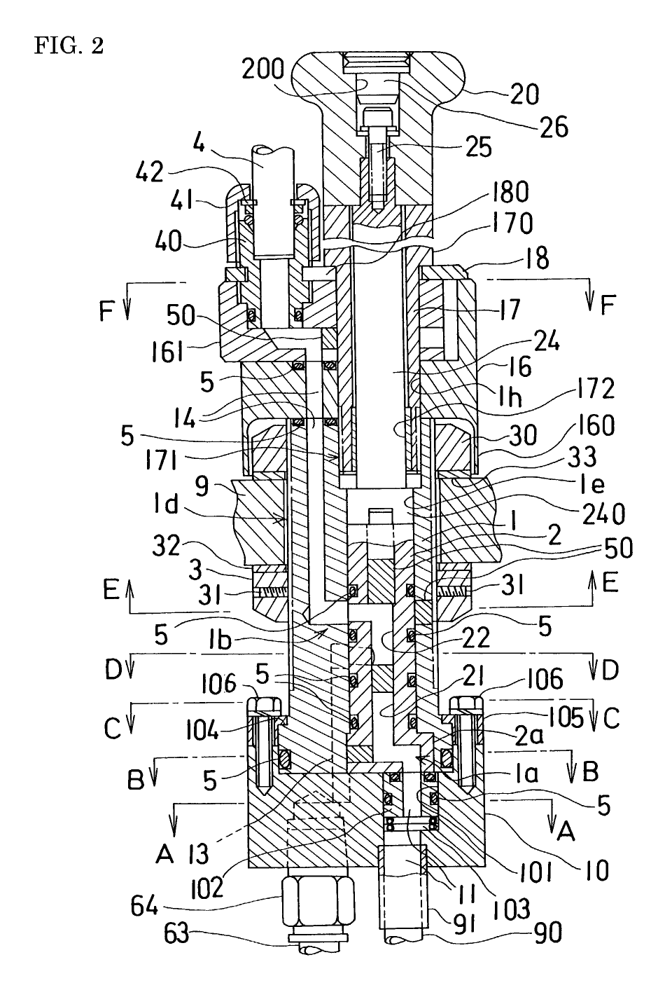

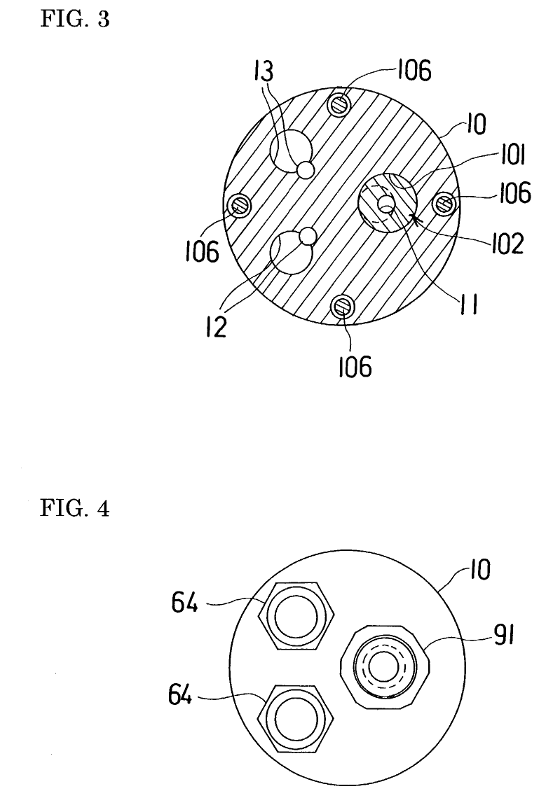

As shown in FIGS. 1 and 2, a cock in one preferred embodiment is mounted perpendicularly to a top plate 9 of a sink cabinet in the manner of penetrating the top plate.

Reference numeral 1 denotes a transformed cylindrical main body, 10 is a bottom block fixed liquid-tightly to a bottom of the main body 1, 16 is a housing connected to an upper part of the main body 1, 20 is a handle for operating a plug, and 4 is a faucet-loaded pipe arranged to communicate with an upper end of a final outflow port of the cock.

A water pipe 90 is arranged to communicate with a first inflow port 11 as will be described later through a joint 91. A treating container 6 such as a water purifier is installed in a storage part under the sink cabinet. A first outflow port 12 as will be described later is arranged to communicate with an inlet 60 of the treating container 6 through a pipe 62, while a second inflow port 13 as will be described later is arranged to communicate with an outlet 61 of the treating container through a pipe 63.

Reference numeral 64 denotes a joint for connecting each of the pipes 62, 63 to the cock.

As shown in FIGS. 2,6, 7, 8, 9 and 10, in the cylindrical main body 7, there is an insertion port 1e that is formed in a position one-sided from an axial center in a circumference direction so as to penetrate the main body perpendicularly, and a plug 2 is inserted into the insertion port 1e liquid-tightly so as to be turned within a predetermined angle. The main body 1 has a thick portion and a thin portion in a circumference direction, because of the presence of the insertion port 1e formed in the one-sided position.

The bottom block 10 is fixed water-tightly to the bottom of the main body 1 so as to block the insertion port 1e. More specifically, the bottom block 10 is fixed to the bottom of the main body 1 by steps of fitting a portion of a flange part 104 formed at a lower part of the main body 1 into the dish-shaped bottom block 10, holding the flange part 104 with a holding ring 105, and then tightening the holding ring 105 and an upside of an outer circumference of the bottom block 10 with four pieces of bolts 106.

A male screw part 1d is formed on the outer circumference of the main body 1, and a mounting flange 3 made up of a nut is mounted to the male screw part 1d. The mounting flange 3 is a lock nut that is fixed to the main body 1 with several pieces of set screws 31 not to be loosened, and a mounting level of the flange 3 may be adjusted by loosening the set screws 31 for unlocking.

The main body 1 is mounted to the top plate 9 of the sink cabinet in the manner of penetrating the top plate. More specifically, the main body 1 is mounted to the top plate 9 by steps of allowing the main body 1 to upward penetrate a hole formed in the top plate 9, then bringing the mounting flange 3 into contact with an underside of the top plate 9 through a washer 32, and then screwing a portion of the main body 1 projecting upward from the top plate 9 with the nut 30 through a washer 33 that also serves as a seal material.

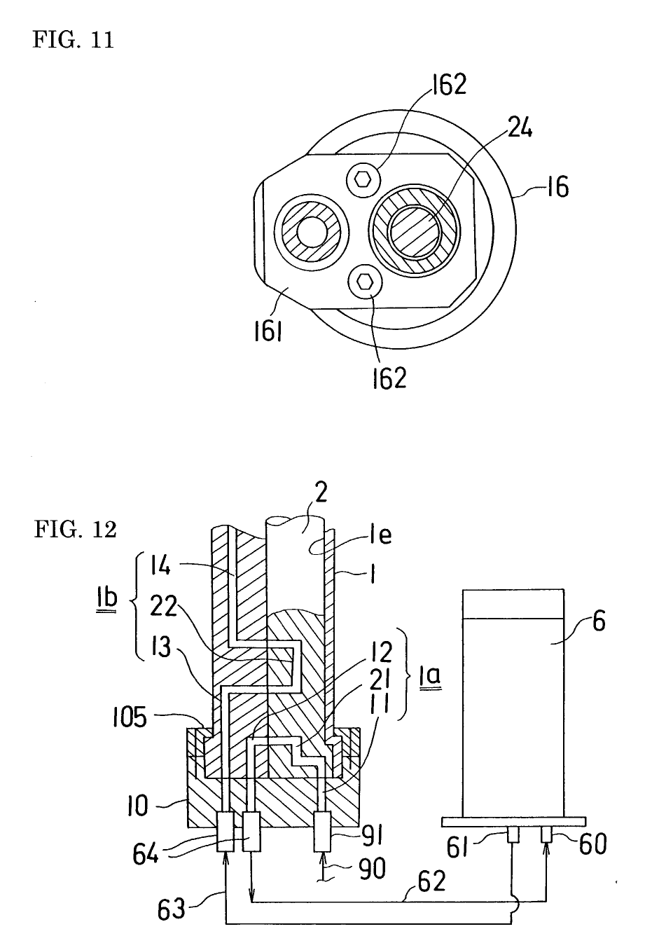

The main body 1 has a housing 16 at its upper part projecting from the top plate 9, and in the housing 16, there is a skirt part 160 that covers the nut 30. The housing 16 has a cover block 161 at its upper part, and the cover block 161 is mounted to the upper part of the housing 16 with a plurality of screws 162 as shown in FIG. 11.

In the housing 16 including the cover block 161, there is an insertion port 1h slightly larger in diameter than the insertion port 1e of the main body 1 so as to be continuous with the insertion port 1e, and a small diameter part at a lower part of a cylindrical shaft holder 17 is inserted into the insertion port 1h.

The shaft holder 17 has a large diameter part 170 at its upper part, and a male screw part 171 is formed on the outer circumference of a lower part of the small diameter part. Then, the housing 16 and the main body 1 are united as one body by steps of placing a holding plate 18 having a slot 180 upon the upper part of the housing 16 including the cover block 161, then inserting the small diameter part of the shaft holder 17 into the insertion port 1e through the slot 180, and then screwing the male screw part 171 of the small diameter part into a large-diameter female screw part that is formed at an upper end of the insertion port 1e of the main body 1.

Reference numeral 172 denotes a bush that is mounted to an inner surface of the lower part of the shaft holder 17.

The plug 2 has, at its upper end, a shaft 24 that is inserted into the shaft holder 17 so as to be freely turned, and the shaft 24 is arranged to turn together with the plug 2 as one body, since a flange part 240 at a lower end of the shaft is engaged with the upper end of the plug 2 in a clutch form.

The handle 20 is mounted to an upper end of the shaft 24 projecting from an upper end of the shaft holder 17 with a bolt 25. A cover 26 is fitted into a hole 200, in which the bolt 25 is embedded, to prevent dust and the like from entering the hole.

In the main body 1 and the plug 2, there are a first cock part 1a that controls the inflow of water into the treating container 6 and a second cock part 1b that controls the outflow of water from the treating container 6.

The first cock part 1a is composed of a first inflow port 11 and a first outflow port 12 respectively formed in the main body 1 and a first connection port 21 formed in the plug 2 to open the first inflow port 11 and the first outflow port 12.

According to the embodiment, in the lower end of the insertion port 1e of the main body 1, there is a sector-shaped hole 1f having a semicircular inner surface 1g about the center of turning axis of the plug 2 so as to be larger in radius than the center of turning axis of the plug 2. In the lower end of the plug 2, there is a sector-shaped shaft part 2a that slides in contact with the inner surface 1g of the sector-shaped hole 1f in the course of turning of the plug. The extent of turning of the plug 2 is regulated by the sector-shaped hole 1f.

As shown in FIGS. 2, 5 and 9, an inlet of the first connection port 21 is formed perpendicularly in a position one-sided from the center of turning axis of the lower end of the plug 2 toward the sector-shaped circumference of the sector-shaped shaft part 2a. An outlet of the first connection port 21 is formed in a position higher than the sector-shaped shaft part 2a so as to extend from the center of turning axis of the plug 2 in the circumference direction in a position of about 130 degrees clockwise from the inlet of the first connection port. The inlet and outlet sides of the first connection port 21 are continuous with each other through a hole that is formed perpendicularly along the center of turning axis of the plug 2.

The bottom block 10 has a hole 101, which is circular in plane, in a portion corresponding to the inlet of the first connection port 21, and a cylindrical block 102 having the perpendicular outlet side of the first inflow port 11 is inserted water-tightly into the hole 101. The cylindrical block 102 is energized toward the plug 2 by the action of a spring 103.

The water pipe 90 is arranged to communicate with the inlet side (the lower part) of the first inflow port 11 through the joint 91.

It is preferable that a check valve (not shown) is mounted to a downstream end of the water pipe 90 or its vicinity to prevent water from flowing backward even if hydraulic pressure in the water pipe 90 falls to zero or less due to damages to the water pipe 90 and other circumstances. This is because backward flowing of water, if occurs due to the above circumstances while the first and second cock parts 1a, 1b are being opened, makes the downstream pipe including the cock and the treating container 6 empty to cause easily the propagation of germs.

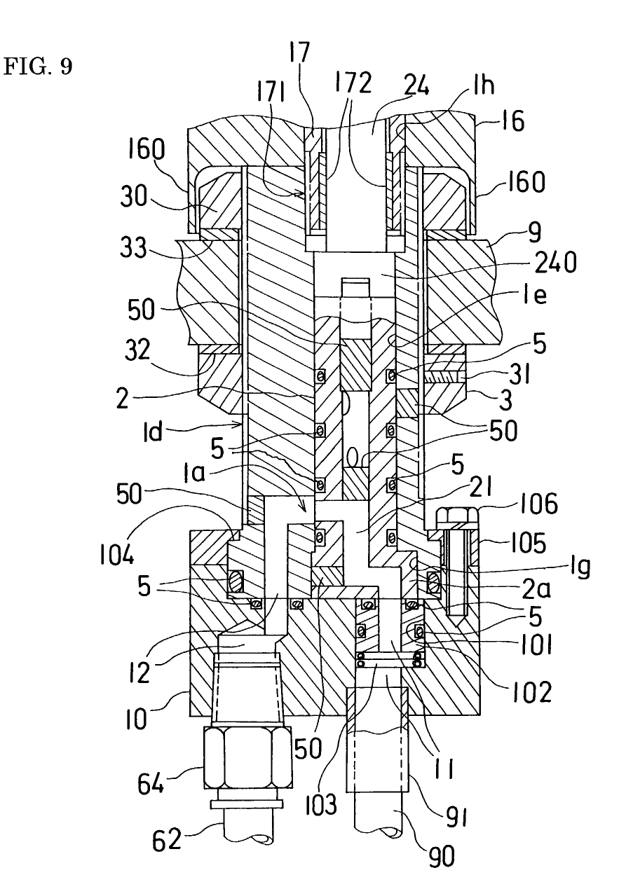

As shown in FIGS. 6 and 9, the first outflow port 12 has an inlet that is formed in the thick portion of the main body 1 to extend in the circumference direction and an outlet that is formed perpendicularly in the bottom block 10. The inlet and outlet of the first outflow port 12 are continuous with each other through a hole that is formed perpendicularly in the thick portion of the main body 1.

A pipe 62 communicating with the inlet 60 of the treating container 6 is arranged to communicate with the outlet of the first outflow port 12 through the joint 64.

The first inflow port 11 and the first outflow port 12 are opened through the first connection port 21 when the plug 2 is turned fully counterclockwise from the closed position of the first cock part 1a through an operation of the handle 20, while being closed when the plug 2 is turned fully clockwise from the opened position of the first cock part.

The second cock part 1b is composed of the second inflow port 13 and a final outflow port 14 respectively formed in the main body 1 and a second connection port 22 formed in the plug 2 to open the second inflow port 13 and the final outflow port 14.

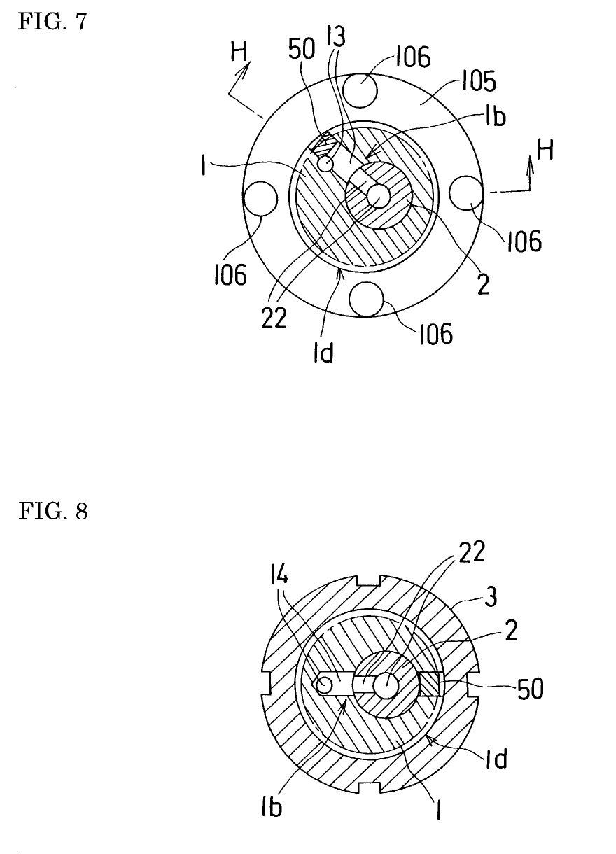

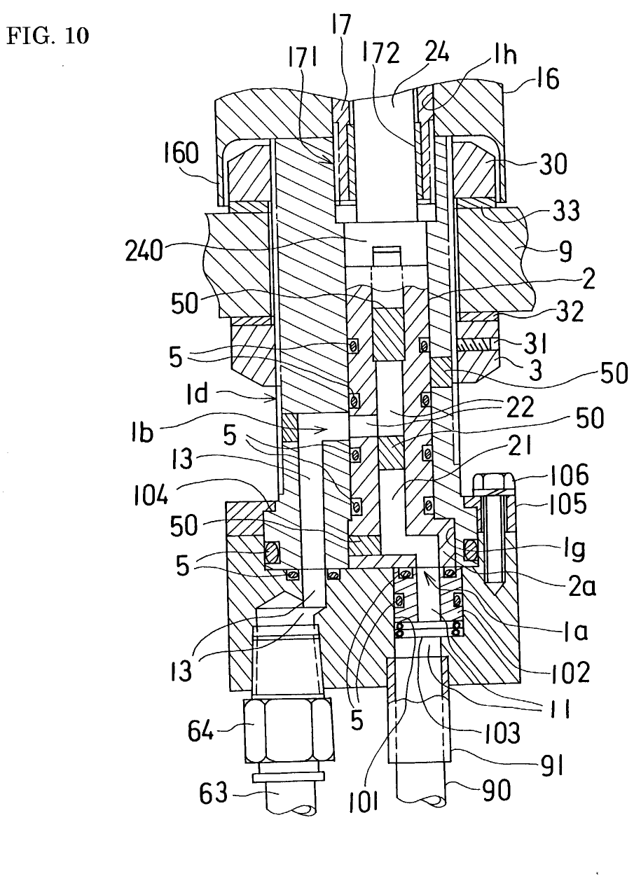

As shown in FIGS. 7 and 10, the second inflow port 13 has an inlet that is formed perpendicularly in the bottom block 10 and an outlet that is formed in the thick portion of the main body 1 to extend toward the axial center of the plug 2. The inlet and outlet of the second inflow port 13 are continuous with each other through a hole that is formed perpendicularly in the thick portion of the main body 1. The outlet of the second inflow port 13 is formed in a position higher than the inlet of the first outflow port 12.

A pipe 63 communicating with the outlet 61 of the treating container 6 is arranged to communicate with an inlet of the second inflow port 13 through the joint 64.

An inlet of the second connection port 22 is formed in a position higher than the outlet of the first connection port 21 so as to extend from the outer circumference of the plug 2 toward the axial center of the plug in a position of about 135 degrees counterclockwise from the inlet of the first connection port 21. An outlet of the second connection port 22 is formed in a position higher than the inlet thereof so as to extend from the axial center of the plug 2 to the circumference direction in a position of about 45 degrees counterclockwise from the inlet. The inlet and outlet of the second connection port 22 are continuous with each other through a hole that is formed perpendicularly along the axial center of the plug 2.

As is clearly shown in FIGS. 6 to 8, the final outflow port 14 is formed in an approximately intermediate position between the first outflow port 12 and the second inflow port 13 in the circumference direction of the main body 1.

The inlet of the final outflow port 14 is formed in the circumferential thick portion of the main body 1 in a position corresponding to the outlet of the second connection port 22 so as to extend in the circumference direction. In other part of the outflow port 14, there is an outlet that is formed perpendicularly in the thick portion of the main body 1 including the housing 16 so as to reach the head. The faucet-loaded pipe 4 is arranged to communicate water-tightly with the outlet of the outflow port 14 through a joint 40 that is screwed into the cover block 161 of the housing 16, as shown in FIG. 2.

Reference numeral 41 denotes a cap nut that is screwed into an upper part of the joint 40, and 42 is an E-shaped retaining ring.

The second inflow port 13 and the final outflow port 14 are opened through the second connection port 22 almost concurrently with opening of the first inflow port 11 and the first outflow port 12 when performed through the first connection port 21, while being closed almost concurrently with closing of the first inflow port 11 and the first outflow port 12 when performed.

To maintain water-tightness of a water running portion of each of the first cock part 1a and the second cock part 1b, O-rings are inserted in a compressed state into required portions of the plug 2 with the main body 1 including the bottom block 10 and the housing 16.

Incidentally, reference numeral 50 denotes a small plug that is fitted under pressure to cover up tightly a required portion of each port formed in the main body 1 and the plug 2.

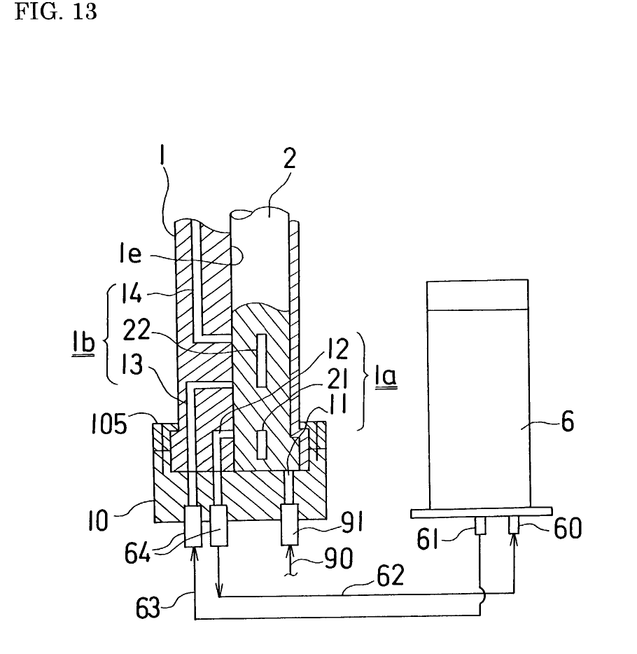

In each drawing excluding FIG. 13, there is shown a state that the first cock part 1a and the second cock part 1b are both opened so that tap water is flowing into the faucet-loaded pipe 4 through the second cock part 1b after being treated with the treating container 6 such as the water purifier through the first cock part 1a. This state may be simplified as shown in FIG. 12 by changing a circumferential position of each of the inflow ports 11, 13, the outflow ports 12, 14 and the connection ports 21, 22.

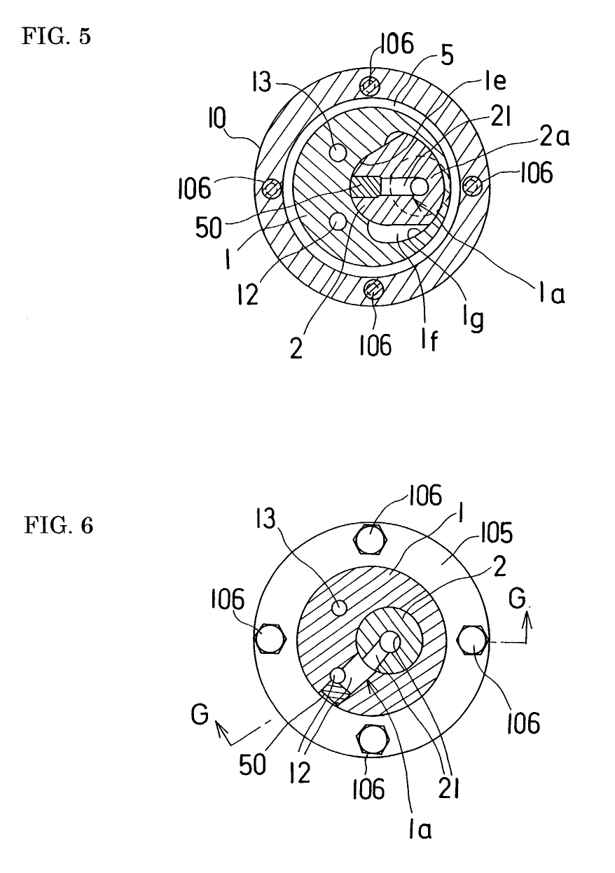

When the plug 2 is turned fully clockwise from the state shown in FIG. 5, for instance, the first inflow port 11 and the first outflow port 12, as well as the second inflow port 13 and the final outflow port 14 are closed with the first connection port 21 and the second connection port 22, so that each of the cocks 1a, 1b is closed. This state may be simplified as shown in FIG. 13 by changing a circumferential position of each of the ports in a similar manner to FIG. 12.

On the other hand, when the plug 2 is turned fully counterclockwise from the state that the cock parts 1a, 1b are closed, the first inflow port 11 and the first outflow port 12, as well as the second inflow port 13 and the final outflow port 14 are opened through the first connection port 21 and the second connection port 22, so that each of the cock parts 1a, 1b is opened (See FIG. 12 that shows the simplified form).

In a case of operating the cock by turning the plug 2 as described the above, the first cock part 1a is controlled to start opening slightly later than a point of time when the second cock part 1b starts opening, and also to start closing slightly earlier than a point of time when the second cock part 1b starts closing.

The above control of the first cock part 1a and the second cock part 1b is performed by adopting the following constitution, for instance.

As shown in FIGS. 6 and 7, for instance, one of means for the above control is supposed to form a connection part of the first outflow port 12 and/or the first inflow port 11 with the first connection port 21 in the first cock part 1a so as to be slightly one-sided in the turning direction (counterclockwise in this embodiment) of the plug 2 on the occasion to open the cock such that the connection part starts opening slightly later than a point of time when the second inflow port 13 and the final outflow port 14 in the second cock part 1b start opening, and also starts closing slightly earlier than a point of time when the second inflow port 13 and the final outflow port 14 start closing. Incidentally, in FIG. 6, the connection part of the first connection port 21 with the first outflow port 12 is one-sided by about 5 degrees in the turning direction of the plug 2 on the occasion to open the cock.

Another means is supposed to form a connection part of the second inflow port 13 and/or the final outflow port 14 with the second connection port 22 in the second cock part 1b so as to be slightly one-sided in the turning direction of the plug 2 (clockwise in this embodiment) on the occasion to close the cock such that the connection part starts opening slightly earlier than a point of time when the first inflow port 11 and the first outflow port 12 in the first cock part 1a start opening, and also starts closing slightly later than a point of time when the first inflow port 11 and the first outflow port 12 start closing.

The cock according to the first embodiment has the effects as follows.

The outlet side of the treating container 6 is opened somewhat earlier than the inlet side thereof when the plug 2 is operated in a direction to open the cock, while the outlet side of the treating container 6 is closed somewhat later than the inlet side thereof when the plug 2 is operated in a direction to close the cock, so that no excessive hydraulic pressure is applied to the treating container 6.

In addition, a single cock is enough to perform the above operations, so that there is no danger of making a mistake in order of operations for inflow to and outflow from the treating container 6.

The mounting flange 3 is mounted to the main body 1, and a portion of the second cock part 1b excluding the inlet of the final outflow port 14 is formed in the main body so as to reach the head along the perpendicular direction, so that the pipe arrangement is made easier and besides, it is easy to mount the cock to the top plate and the like of the sink cabinet in a case of installing the water purifier and the like in the storage part under the sink cabinet, while mounting the cock so as to permit the inflow/outflow operations of the water purifier and the like on the sink cabinet.

The male screw part 1d is formed at least on a part of the outer circumference of the main body 1, and the mounting flange 3 used herein is the lock nut that is screwed onto the male screw part 1d, so that the mounting level of the flange 3 may be adjusted by unlocking the flange 3. There is the mounting nut 30 that may be mounted to the male screw part 1d, so that it is easy to mount the cock to the top plate and the like of the sink cabinet in the manner of penetrating the top plate.

The main body 1 has the housing 16 at its upper part, and the housing 16 has the skirt part 160 that may cover the nut 30, so that an essential part of the cock projecting upward from the top plate may be covered, when the cock is mounted to the top plate and the like of the sink cabinet in the manner of penetrating the top plate.

The main body 1 has the bottom block 10 mounted liquid-tightly to the bottom, the first inflow port 11 is formed perpendicularly in the bottom block 10, and the portion of the first outflow port 12 excluding the inlet thereof and the portion of the second inflow port 13 excluding the outlet thereof are formed along the perpendicular direction in the main body 1 including the bottom block 10 to permit the pipes to be arranged along the axial direction of the main body 1, so that it is possible to shorten the main body 1 relatively, and besides, to eliminate the main body from the expansion in the circumference direction due to the pipe arrangement.

The inlet of the first connection port 21 is formed perpendicularly in the position one-sided from the center of turning axis of the plug 2 in the circumference direction, and the first inflow port 11 and the first connection port 21 are opened and closed by making slide motions along a plane made up of the underside of the plug 2 and the upside of the bottom block 10 through the operation of the plug 2, so that it is easy to maintain water tightness of the part for the first inflow to the cock.

In the bottom block 10, the cylindrical block 102 having the perpendicular portion of the first inflow port 11 is embedded liquid-tightly in the portion corresponding to the inlet of the first connection port 21, and is also energized toward the plug 2 by the action of the spring 103, so that the water tightness of the part for the first inflow to the cock is maintained completely.

In addition, because of the achievement of complete water tightness of the part for the first inflow to the cock, water existing in the first inflow port 11 may be prevented from flowing backward in a direction of the water pipe 90, even if the hydraulic pressure of the water pipe 90 falls to zero or less due to the damages to the water pipe 90 and other circumstances while the cock parts 1a, 1b are being closed. Thus, it is possible to prevent the propagation and the like of germs caused by a loss of tap water within the first inflow port 11.

The main body 1 has the thick portion and the thin portion in the circumference direction because of the presence of the insertion port 1e formed in the one-sided position, and the first outflow port 12, the second inflow port 13 and the final outflow port 14 are formed in the thick portion on the peripheral wall of the main body 1, so that it is possible to make the outer diameter of the main body 1 relatively smaller.

The first outflow port 12, the second inflow port 13 and the final outflow port 14 are formed in the main body 1 at different positions in the circumference direction, so that it is possible to make the outer diameter of the main body 1 further smaller.

The extent of turning of the plug 2 is regulated by the sector-shaped hole 1f, so that the cock may be opened and closed by turning the plug 2 fully in the normal direction or the reverse direction.

A description will now be given of a second embodiment according to the present invention.

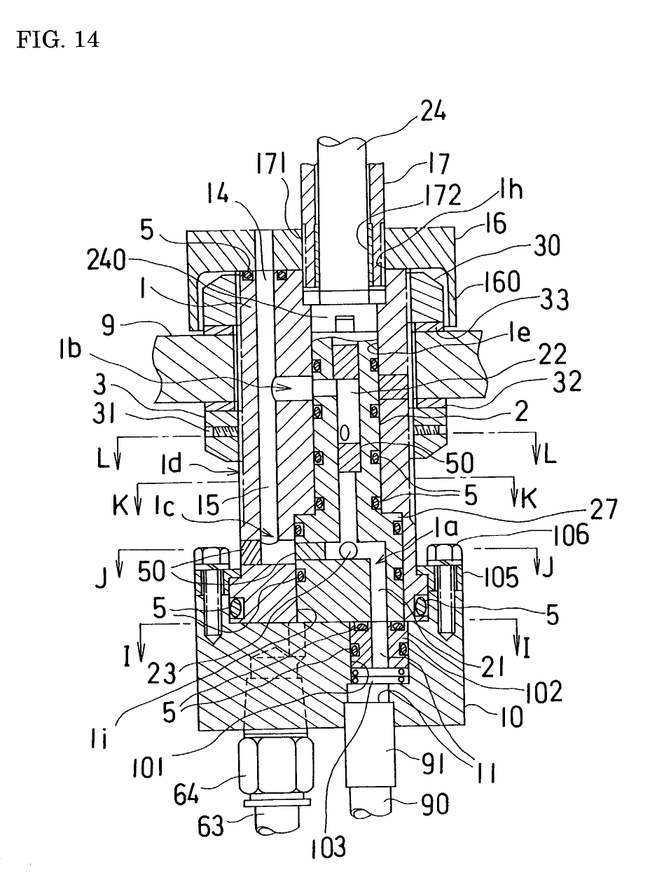

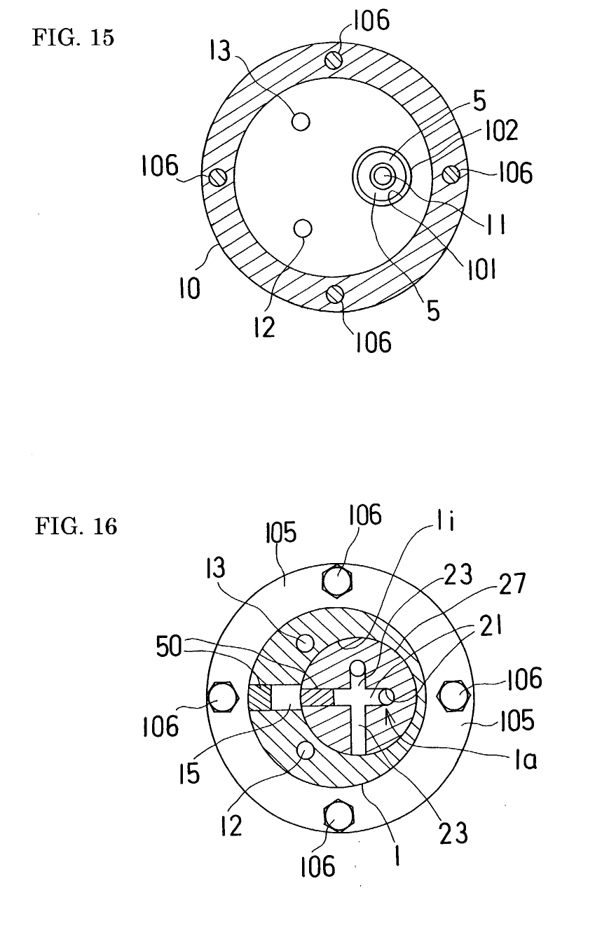

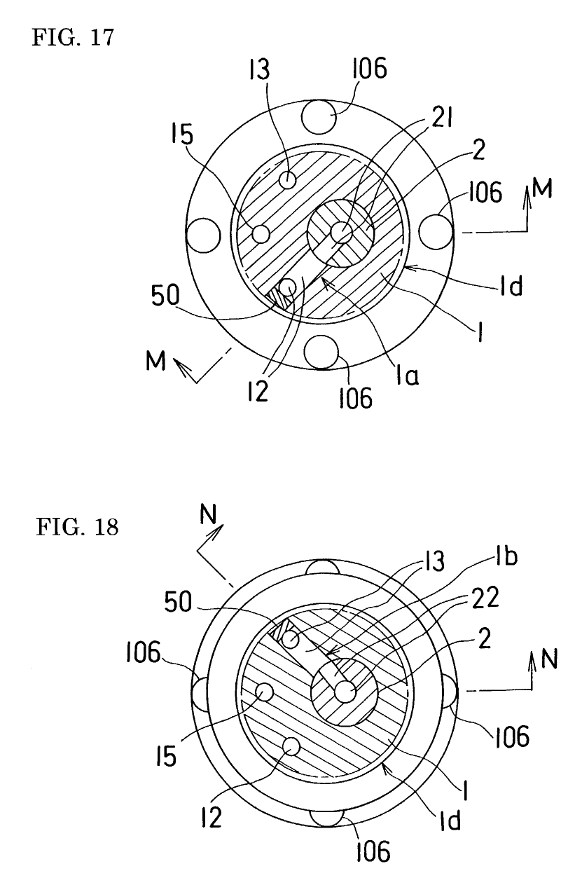

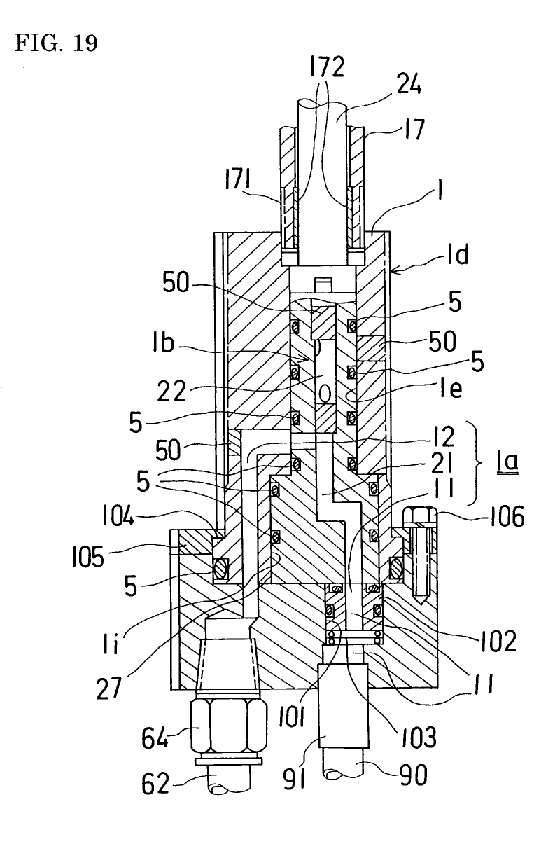

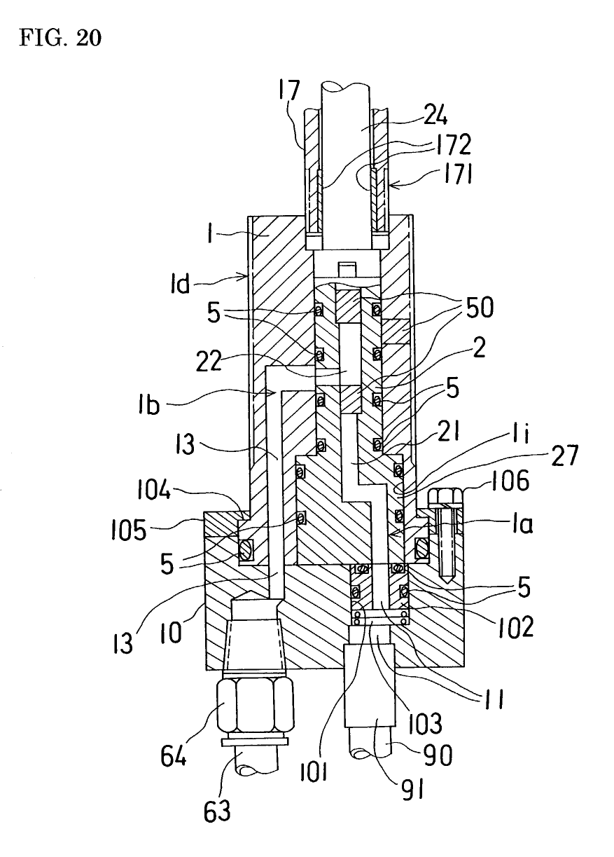

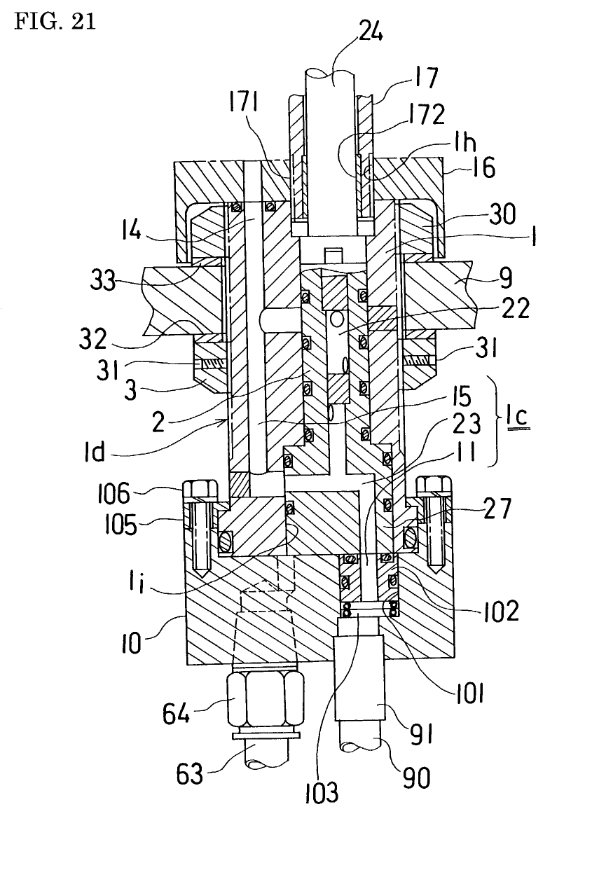

FIG. 14 is a partial longitudinal cross-sectional view showing the second embodiment of the cock according to the present invention, FIG. 15 is a cross-sectional view taken along arrow I-I in FIG. 14, FIG. 16 is a cross-sectional view taken along arrow J-J in FIG. 14, FIG. 17 is a cross-sectional view taken along arrow K-K in FIG. 14, FIG. 18 is a cross-sectional view taken along arrow L-L in FIG. 14, FIG. 19 is a cross-sectional view taken along arrow M-M in FIG. 17, FIG. 20 is a cross-sectional view taken along arrow N-N in FIG. 18 and FIG. 21 is a partial longitudinal cross-sectional view showing a state that a third cock part 1c is opened.

The cock in the second embodiment is different from the cock in the first embodiment in constitution. That is, the cock in the second embodiment has the third cock part 1c, in addition to the first cock part 1a and the second cock part 1b that are substantially similar to those of the cock in the first embodiment. Other constitution is substantially the same as the cock in the first embodiment, so that the reference numerals used in the first embodiment are also used for the corresponding components, and hence, their detailed description will be omitted, unless otherwise required.

The first and second cock parts 1a, 1b control the inflow and outflow of water to the water purifier and the like approximately at the same time, while the third cock part 1c is used to control the tap water for flowing from the water pipe to the faucet-loaded pipe without passing through the water purifier and the like.

The third cock part 1c is composed of a first inflow port 11 formed perpendicularly in the bottom block 10 of the main body 1, a third outflow port 15 formed such that a portion excluding an inlet is formed in the thick portion of the main body 1 so as to extend upward along the perpendicular direction, and an end (an outlet) is arranged to communicate with a lower end of a perpendicular part of the final outflow port 14, and a third connection port 23 formed in the plug 2 to open the inflow port 11 and the outflow port 15.

As shown in FIG. 14, a large-diameter insertion port 1i is formed in a lower end portion of an insertion port 1e that is formed one-sidedly in the main body 1 in the perpendicular direction, and a large-diameter insertion part 27 conformably inserted into the large-diameter insertion port 1i is formed in a lower end portion of the plug 2.

An inlet of a first connection port 21 is formed perpendicularly in a portion of the large-diameter insertion part 28 in a position one-sided from the center of turning axis of the plug 2 in the circumference direction, and an outlet of the first connection port 21 is formed in a position higher than the inlet thereof so as to extend from the center of turning axis in the circumference direction as shown in FIGS. 17 and 19. The inlet and outlet of the first connection port 21 are continuous with each other through a hole that extends from the inlet of the first connection port 21 toward the axial center, together with a hole that is formed perpendicularly upward along the axial center.

As shown in FIGS. 14 and 16, the third connection port 23 is formed in a portion of the large-diameter insertion part 27 so as to cross at right angles to the hole that extends from the inlet of the first connection port 21 toward the axial center. An inlet of the third connection port 23 is formed perpendicularly in a position of about 45 degrees counterclockwise from the inlet of the first connection port 21. An outlet of the third connection port 23 reaches the outer circumference on the side opposite to the inlet thereof.

As shown in FIG. 17, the first outflow port 12 and the second inflow port 13 are different by 90 degrees in position in the circumference direction from the center of turning axis (the center of turning axis of the plug 2, the same will be applied hereinafter), while the first outflow port 12 is equal with the second inflow port 13 in distance in the circumference direction from the center of turning axis. The positions of the third outflow port 15 and the final outflow port 14 are at the substantially middle between the first outflow port 12 and the second inflow port 13, so that the third outflow port and the final outflow port are substantially equal with the first outflow port 12 and the second inflow port 13 in distance in the circumference direction from the center of turning axis.

A regulating means (not shown) is provided in a portion of the slide part of the plug 2 in the turning direction with the main body 1 so as to regulate turning of the plug 2 to 90 degrees or less at maximum from the position of FIG. 16.

FIGS. 14 to 20 show a state that the first cock part 1a and the second cock part 1b are both opened so that the tap water is flowing into the faucet-loaded pipe 4 through the second cock part 1b after being treated with the treating container such as the water purifier through the first cock part 1a.

When the plug 2 is turned clockwise by about 45 degrees from the state of FIG. 16, for instance, the first inflow port 11 and the first outflow port 12, as well as the second inflow port 13 and the final outflow port 14, are closed with the first connection port 21 and the second connection port 22, so that each of the cock parts 1a, 1b is closed.

On the other hand, when the plug 2 is turned counterclockwise by about 45 degrees from the state that the cocks 1a, 1b are closed, the first inflow port 11 and the first outflow port 12, as well as the second inflow port 13 and the final outflow port 14, are opened through the first connection port 21 and the second connection port 22, so that each of the cock parts 1a, 1b is opened.

According to the second embodiment, as shown in FIG. 18, a connection part of the second inflow port 13 and/or the final outflow port 14 with the second connection port 22 in the second cock part 1b is formed so as to be slightly one-sided (about 5 degrees) in the turning direction (clockwise in this embodiment) of the plug 2 on the occasion to close the cock parts 1a, 1b such that the connection part starts opening slightly earlier than a point of time when the first inflow port 11 and the first outflow port 12 in the first cock part 1a start opening, and also starts closing slightly later than a point of time when the first inflow port 11 and the first outflow port 12 start closing. Thus, in a case of operating the cock by turning the plug 2 as described the above, the first cock part 1a may be controlled to start opening slightly later than a point of time when the second cock part 1b starts opening, and also to start closing slightly earlier than a point of time when the second cock part 1b starts closing.

Instead of the above constitution, the connection part of the first inflow port 11 and/or the first outflow port 12 with the first connection port 21 in the first cock part 1a may be also formed so as to be slightly one-sided in the turning direction (counterclockwise in this embodiment) of the plug 2 on the occasion to open the cock such that the connection part starts opening slightly later than a point of time when the second inflow port 13 and the final outflow port 14 in the second cock part 1b start opening, and also starts closing slightly earlier than a point of time when the second inflow port 13 and the final outflow port 14 start closing.

According to the second embodiment, the plug 2 is stopped if turned clockwise by 90 degrees from the state shown in FIG. 16, for instance, so that the first cock part 1a and the second cock part 1b are closed, while the third cock part 1c composed of the first inflow port, the third connection port 23 and the third outflow port 15 is opened together with the final outflow port 14. As a result, water (tap water) having been flowed from the water pipe 90 into the cock flows into the faucet-loaded pipe 4 through the third cock part 1a and the final outflow port 14 without passing through the treating container such as the water purifier.

Thus, the cock according to the second embodiment has advantages of eliminating the need for special pipe used to allow the tap water in the water pipe to flow directly to the sink without passing through the water purifier and the like.

Other operations and effects of the cock according to the second embodiment are substantially similar to those of the cock according to the first embodiment, and hence, their detailed description will be omitted.

A description will now be given of a third embodiment according to the present invention.

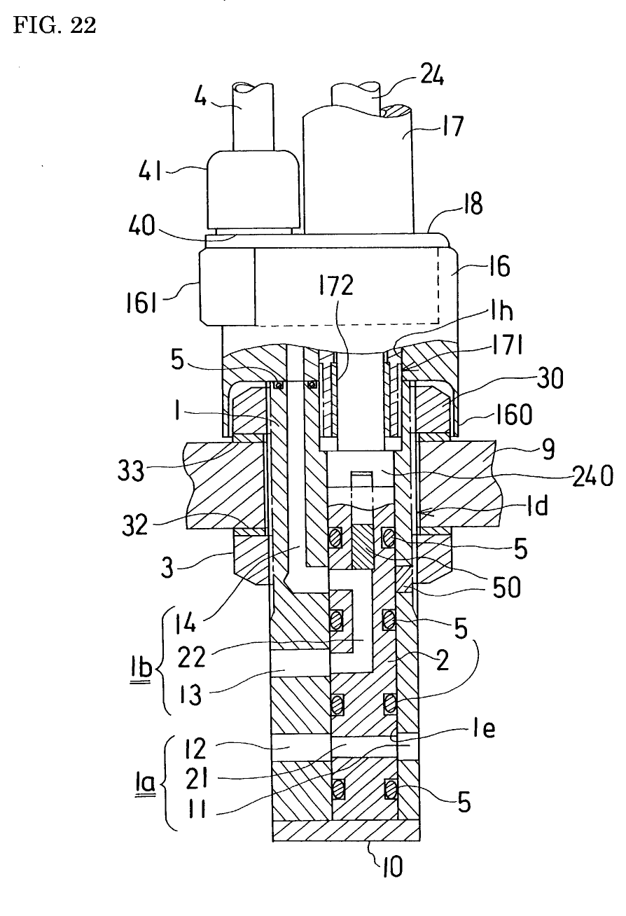

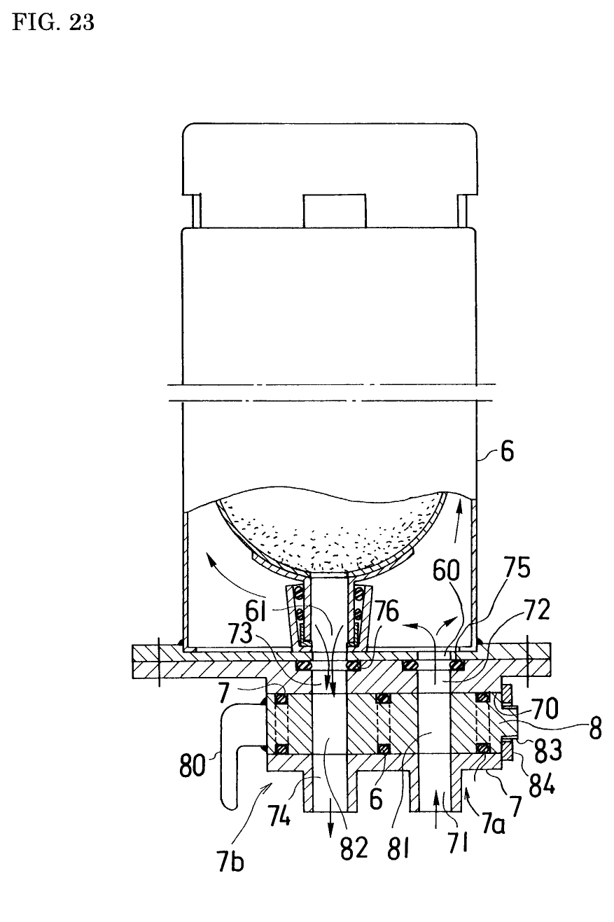

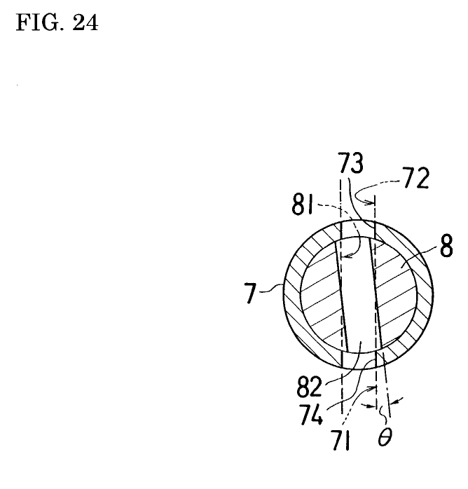

FIG. 22 is a cross-sectional view showing a cock in the third embodiment according to the present invention.

Into a transformed cylindrical main body 1 having an insertion port 1e formed in a position one-sided from the axial center in the circumference direction, a cylindrical plug 2 is inserted water-tightly so as to be turned within a predetermined angle (90 degrees, for instance). A bottom block 10 is water-tightly fixed to the bottom of the main body 1.

In the main body 1, there are a first inflow port 11 and a first outflow port 12 that are formed in a position close to a lower part so as to extend from a circumferential thin portion to a circumferential thick portion in a radial direction. In the plug 2, there is a first connection port 21 that penetrates in a radial direction to open the inflow port 11 and the outflow port 12 when the cock is opened. These ports 11, 21 and 12 provide a first cock part 1a.

A second inflow port 13 is formed in a position higher than the first outflow port 12 of the main body 1 so as to extend from the same circumference direction as the outflow port 12 toward the axial center. In a position higher than the second inflow port 13, a portion of the final outflow port 14 excluding an inlet thereof is formed perpendicularly in a position in the same circumference direction so as to reach the head of the main body 1. A second connection port 22 is formed in the plug 2 to open the inflow port 13 and the outflow port 14 when the cock is opened. These ports 13, 22 and 14 provide a second cock part 1b.

An upper end of the final outflow port 14 is arranged to communicate with the faucet-loaded pipe 4 through a joint 40.

A water pipe (not shown) is arranged to communicate with the first inflow port 11, an inlet of a treating container such as the water purifier (not shown) is arranged to communicate with the first outflow port 12, and an outlet of the treating container (not shown) is arranged to communicate with the second inflow port 13.

FIG. 22 shows a state that the first cock part 1a and the second cock part 1b are both opened, so that the tap water having been flowed into the first inflow port 11 is fed from the faucet-loaded pipe 4 through the second cock part 1b after being treated with the treating container through the first cock part 1a.

When the plug 2 is turned clockwise by 90 degrees from an illustrated state, the first cock part 1a is closed, while the second cock part 1b is closed slightly later than a point of time when the first cock part is closed. On the other hand, when the plug 2 is turned counterclockwise by 90 degrees from the state that the cock parts 1a, 1b are closed as described the above, the second cock part 1b is opened, while the first cock part 1a is opened slightly later than a point of time when the second cock part is opened.

The specific control means for the cock parts 1a, 1b as described in terms of the cock in the first embodiment is also available for the cock in the third embodiment.

The cock in the third embodiment has the first inflow port 11, the first outflow port 12 and the second inflow port 13 that are formed along the circumference direction of the main body 1, so that the constitution of the main body 1 and the plug 2 is more simplified in a connection part of the main body 1 with the water pipe (hot shown) and a connection part of the main body 1 with the treating container (not shown), although a piping part expanded in the circumference direction is required.

Other constitution, operations and effects of the cock in the third embodiment are substantially similar to those of the cock in the first embodiment, and hence, their detailed description will be omitted.

According to the cock of the present invention as defined in claim 1, the outlet side of the treating container such as the water purifier is opened somewhat earlier than the inlet side thereof when the plug is operated in the direction to open the cock, while the outlet side of the treating container is closed somewhat later than the inlet side thereof when the plug is operated in the direction to close the cock, so that no excessive hydraulic pressure is applied to the treating container.

In addition, a single cock is enough to perform the above operations, so that there is no danger of making a mistake in order of operations for inflow to and outflow from the treating container.

The mounting flange 3 is mounted to the main body 1, and the portion of the second cock part 1b excluding the inlet of the final outflow port 14 is formed in the main body so as to reach the head along the perpendicular direction, so that the pipe arrangement is made easier and besides, it is easy to mount the cock to the top plate and the like of the sink cabinet in a case of installing the water purifier and the like to the storage part under the sink cabinet, while mounting the cock so as to permit the inflow/outflow operations of the water purifier and the like on the sink cabinet. According to the cock of the present invention as defined in claim 2, the male screw part 1d is formed at least on a part of the outer circumference of the main body 1, and the mounting flange 3 used herein is the lock nut that is screwed onto the male screw part 1d, so that the mounting level of the flange 3 may be adjusted by unlocking the flange 3. There is the mounting nut 30 that may be mounted to the male screw part 1d, so that it is easier to mount the cock to the top plate and the like of the sink cabinet in the manner of penetrating the top plate.

According to the cock of the present invention as defined in claim 3, the main body 1 has the housing 16 at its upper part, and the housing 16 has the skirt part 160 that may cover the nut 30, so that the essential part of the cock projecting upward from the top plate may be covered when the cock is mounted to the top plate and the like of the sink cabinet in the manner of penetrating the top plate.

According to the cock of the present invention as defined in claim 4, the main body 1 has the bottom block 10 mounted liquid-tightly to the bottom, the first inflow port 11 is formed perpendicularly in the bottom block 10, and the portion of the first outflow port 12 excluding the inlet thereof and the portion of the second inflow port 13 excluding the outlet thereof are formed along the perpendicular direction in the main body 1 including the bottom block 10 to permit the pipes to be arranged along the axial direction of the main body 1, so that it is possible to shorten the main body 1 relatively, and besides, to eliminate the main body from the expansion in the circumference direction due to the pipe arrangement.

According to the cock of the present invention as defined in claim 5, the inlet of the first connection port 21 is formed perpendicularly in the position one-sided from the center of turning axis of the plug 2 in the circumference direction, and the first inflow port 11 and the first connection port 21 are opened and closed by making slide motions along the plane made up of the underside of the plug 2 and the upside of the bottom block 10 through the operation of the plug 2, so that it is easy to maintain the water tightness of the part for the first inflow to the cock.

According to the cock of the present invention as defined in claim 6, the cylindrical block 102 having the perpendicular portion of the first inflow port 11 is liquid-tightly embedded in the bottom block 10 in the portion corresponding to the inlet of the first connection port 21, and is further energized toward the plug 2 by the action of the spring 103, so that the water tightness of the part for the first inflow to the cock may be maintained more completely.

In addition, because of the achievement of complete water tightness of the part for the first inflow to the cock, water existing in the first inflow port 11 may be prevented from flowing backward in the direction of the water pipe 90, even if the hydraulic pressure of the water pipe 90 falls to zero or less due to the damages to the water pipe 90 and other circumstances while the cock parts 1a, 1b are being closed. Thus, it is possible to prevent the propagation and the like of the germs caused by a loss of tap water in the first inflow port 11.

According to the cock of the present invention as defined in claim 7, the main body 1 has the thick portion and the thin portion in the circumference direction because of the presence of the insertion port 1e formed in the one-sided position, and the first outflow port 12, the second inflow port 13 and the final outflow port 14 are formed in the thick portion of the peripheral wall of the main body 1, so that it is possible to make the outer diameter of the main body 1 smaller relatively.

According to the cock of the present invention as defined in claim 8, the first outflow port 12, the second inflow port 13 and the final outflow port 14 are formed in the main body 1 at different positions in the circumference direction, so that it is possible to make the outer diameter of the main body 1 further smaller.

According to the cock of the present invention as defined in claim 9, the extent of turning of the plug 2 is regulated by the sector-shaped hole 1f, so that the cock may be opened and closed by turning the plug 2 fully in the normal direction or in the reverse direction.

According to the cock of the present invention as defined in claim 10, the cock further has the third cock part 1c that controls the tap water for flowing from the water pipe to the faucet-loaded pipe without passing through the water purifier and the like, in addition to the first cock part 1a that controls the inflow of water to the treating container, and the second cock part 1b that controls the outflow of water from the treating container, so that the cock has advantages of eliminating the need for special pipe used to allow the tap water in the water pipe to flow directly to the sink without passing through the water purifier and the like.

What is claimed is:

1. A cock, comprising:
a main body having an insertion port formed in a perpendicular direction;
a plug inserted into said main body liquid-tightly so as to be turned normally and reversely within a predetermined angle, and having a handle at a head projecting from said main body;
a mounting flange mounted to said main body;
a first cock part permitting a first inflow port and a first outflow port respectively formed in said main body to be opened and closed through a first connection port formed in said plug; and
a second cock part permitting a second inflow port and a final outflow port respectively formed in said main body to be opened and closed through a second connection port formed in said plug;
wherein a portion of said final outflow port excluding an inlet thereof is formed in said main body so as to reach a head along the perpendicular direction;
said first cock part and said second cock part are opened and closed concurrently through an operation of said plug; and
said first cock part is controlled to start opening slightly later than a point of time when said second cock part starts opening, and also to start closing slightly earlier than a point of time when said second cock part starts closing.

2. The cock according to claim 1, wherein a male screw part is formed at least on a part of the outer circumference of said main body, and said mounting flange is a lock nut that is screwed onto said male screw part, and a mounting nut that may be mounted to said male screw part is provided.

3. The cock according to claim 2, wherein said main body has a housing at its upper part, said housing has, at its lower part, a skirt part that may cover said mounting nut, said plug includes a shaft provided at its upper part so as to be turned together with said plug as one body, said shaft penetrates said housing so as to be freely turned, said handle is mounted to a head of said shaft, and said final outflow port is arranged to communicate with a faucet-loaded pipe through said housing.

4. The cock according to claim 1, wherein said main body includes a bottom block mounted liquid-tightly to the bottom, said first inflow port is formed perpendicularly in said bottom block, a portion of said first outflow port excluding an inlet thereof is formed along the perpendicular direction in said main body including said bottom block, and a portion of said second inflow port excluding an outlet thereof is formed along the perpendicular direction in said main body including said bottom block.

5. The cock according to claim 4, wherein an inlet of said first connection port is formed in a position one-sided from the center of turning axis of said plug, and said first inflow port is formed in a position where said first inflow port is opened and closed through said first connection port by turning of said plug.

6. The cock according to claim 5, wherein said bottom block has a hole, which is circular in plane, in a portion corresponding to the inlet of said first connection port, and a cylindrical block having a portion of the first inflow port is inserted liquid-tightly into said hole, and is further energized toward said plug by the action of a spring.

7. The cock according to claim 4, wherein said main body has a thick portion and a thin portion in the circumference direction because of the presence of the insertion port formed in the one-sided position, and said first outflow port, said second inflow port and said final outflow port are formed in the thick portion of a peripheral wall of said main body.

8. The cock according to claim 4, wherein said first outflow port, said second inflow port and said final outflow port are formed in said main body at different positions in the circumference direction.

9. The cock according to claim 1, wherein a sector-shaped hole having a semicircular-shaped inner surface about the center of turning axis of said plug so as to be larger in radius than the center of turning axis of said plug is formed in a lower part of the insertion port of said main body, a sector-shaped shaft part that slides in contact with said inner surface of said sector-shaped hole in the course of turning of said plug is formed at a lower end of said plug, and the extent of turning of said plug is regulated by said sector-shaped hole.

10. The cock according to claim 1, wherein it further comprises a third cock part permitting a first inflow port and a third outflow port respectively formed in said main body to be opened and closed through a third connection port formed in said plug, an end of said third outflow port is arranged to communicate with said final outflow port, and said third cock part is opened when said plug is turned by a predetermined angle from a state that said first cock part and said second cock part are open to a state that the cock parts are both closed.
